(19) United States
(12) Patent Application Publication
(10) Pub. No.: US 2018/0167528 A1
(43) Pub. Date: Jun. 14, 2018

(54) ELECTRONIC APPLIANCE

(71) Applicant: CANON KABUSHIKI KAISHA, Tokyo (JP)

(72) Inventor: Kenji Kuroki, Toride-shi (JP)

(21) Appl. No.: 15/808,644

(22) Filed: Nov. 9, 2017

(30) Foreign Application Priority Data
Dec. 8, 2016 (JP) 2016-238158

(51) Int. Cl. H04N 1/00

(52) U.S. Cl. CPC H04N 1/00933; H04N 2201/0082

(57) ABSTRACT

An electronic appliance including: a first circuit board including a first processor; a second circuit board; a communication signal line configured to connect between the first circuit board and the second circuit board; and a watchdog timer reset IC, wherein the second circuit board includes: a second processor; a receiving portion configured to receive a signal via the line; a first input/output port configured to output a first signal based on an instruction from the second processor; a second input/output port configured to output a second signal in response to the receiving portion receiving a predetermined signal from the first processor; and a logical operation circuit configured to output a watchdog signal based on a logical operation result of the first signal and the second signal, and wherein the watchdog timer reset IC is configured to output a reset signal for resetting the second processor based on the watchdog signal.

### BACKGROUND OF THE INVENTION

### Field of the Invention

The present invention relates to an electronic appliance including a first processor and a second processor.

### Description of the Related Art

Hitherto, in a printer device and other electronic appliances, a central processing unit (CPU) and a system on chip (SoC), which output motor control signals, have been installed in each of a plurality of circuit boards in a distributed manner as illustrated in FIG. 14 in order to control an actuator such as a stepping motor or a direct current (DC) brushless motor installed in each of places like a paper feeding portion, a registration portion, a paper ejection portion, and a drum portion. FIG. 14 is a block diagram for illustrating a configuration of a controller 100 used for the related-art electronic appliance.

In particular, in a printer device required to have high productivity and image positioning accuracy, an SoC, which includes a hard logic for motor control and communication between large-scale integration (LSI) circuits built in a CPU, is often used so as to enhance the responsiveness of the CPU to an input from a sensor more than that of a generic CPU. In the case of such installation, a system using a two-wire or three-wire serial communication system is in general use for connection between a main SoC, which issues an instruction on entire control timing to drive the actuator in each place, and the CPU or the SoC installed on each circuit board in order to perform transmission by fewer signal lines.

Consequently, a procedure for driving the actuator in each place takes a form in which a main SoC 101 transmits a communication packet for making a processing request of a sub SoC 102 by serial communication, and the sub SoC 102 receives and interprets this communication packet, to thereby output a pulse signal for driving the actuator.

However, for example, there are cases in which serial communication signal lines 103 and 104 between the main SoC 101 and the sub SoC 102 are disconnected due to a contact failure. There are also cases in which a CPU 131 built in the sub SoC 102 cannot continue its operation for some reason during the drive of the actuator in each place, and the sub SoC 102 cannot interpret the serial communication packet for stopping the drive of the actuator even when this packet is transmitted. In such cases, it may not be possible to stop the actuator.

In order to deal with such circumstances, a configuration as described below has been used. A watchdog timer reset integrated circuit (IC) 183 is connected to the outside of the sub SoC 102 in advance. The main SoC 101 transmits to the sub SoC 102 a serial communication packet containing an instruction to output a watchdog pulse 105 at a constant frequency, and the sub SoC 102 outputs the watchdog pulse 105 in accordance with the instruction. Then, when the sub SoC 102 cannot output the watchdog pulse 105 due to disconnection of the serial communication signal lines 103 and 104, failure to interpret the serial communication packet, or some other reason, a safety mechanism has been used where the watchdog timer reset IC 183 resets the sub SoC 102 to stop the operation of the actuator (Japanese Patent Application Laid-Open No. 2008-142913).

Firmware used in the built-in CPU 131 in the sub SoC 102 in the connection form as described above is often configured to be separated into a plurality of control sections such as a section to control transmission and reception of the serial communication packet and a section to control the actuator and an I/O port.

In the case of such a configuration, even when information of a RAM 135 used by the sub-CPU 131 in the sub SoC 102 is partially missing due to some disturbance factor, and the serial communication packet received from the main CPU 111 cannot be read, it may be possible to continue operation of an I/O port 143 that is operating separately. In this case, outputting the watchdog pulse 105 is continued. That is, in this case, it is not possible to stop the output of the watchdog pulse 105 to the watchdog timer reset IC 183.

As described above, with the related-art configuration, it may not have been possible to reset the watchdog in the sub SoC 102 depending on the abnormality occurrence status in the sub SoC 102.

For example, in the printer device, when the serial communication signal lines 103 and 104 are cut off while a feeding roller is being driven by a feeding motor or a registration roller is being driven by a registration motor, instructions to stop the feeding roller and the registration roller cannot be received from the main SoC 101.

In such a case, the sub-CPU 131 normally detects a communication abnormality and stops a feeding motor (Ml) 140 and a registration motor (M2) 141. However, when a program on the sub-CPU 131 cannot continue its normal operation for some reason, it may not be possible to perform processing of stopping the feeding motor (M1) 140 or the registration motor (M2) 141.

At this time, when the sub-CPU 131 cannot output the watchdog pulse 105 to the watchdog timer reset IC 183, the watchdog timer reset IC 183 can assert a reset signal 106 to the sub SoC 102 so that the sub SoC 102 can cause a power-on reset circuit (POR) 181 to stop a PWM circuit 139 that outputs a motor control signal.

However, when an abnormality partially occurs in a program in the sub-CPU 131 and results in a state where the stopping control for the feeding motor (M1) 140 and the registration motor (M2) 141 cannot be performed via the serial communication while the output control for the watchdog pulse 105 is in normal operation, the watchdog timer reset IC 183 cannot assert the reset signal 106 to the sub SoC 102 due to the above-mentioned reason. Consequently, it may not have been possible to stop the feeding motor (M1) 140 and the registration motor (M2) 141 even when the abnormality as described above has occurred.

As described above, there is a problem in that the related-art electronic appliance may not appropriately deal with an unexpected abnormality of the sub SoC 102 or some other event.

### SUMMARY OF THE INVENTION

The present invention has been made to solve the above-mentioned problem. The present invention provides an electronic appliance including a first processor and a second processor, which appropriately deals with an unexpected abnormality.

According to one embodiment of the present invention, there is provided an electronic appliance comprising:

a first circuit board including a first processor;

a second circuit board;

a communication signal line configured to connect between the first circuit board and the second circuit board; and

a watchdog timer reset integrated circuit,

wherein the second circuit board includes:
a second processor;
a receiving portion configured to receive a signal input via the communication signal line;
a first input/output port configured to output a first signal based on an instruction from the second processor;
a second input/output port configured to output a second signal in response to the receiving portion receiving a predetermined signal from the first processor; and
a logical operation circuit configured to output a watchdog signal based on a logical operation result of the first signal and the second signal, and

wherein the watchdog timer reset integrated circuit is configured to output a reset signal for resetting the second processor based on the watchdog signal.

Further features of the present invention will become apparent from the following description of exemplary embodiments with reference to the attached drawings.

### BRIEF DESCRIPTION OF THE DRAWINGS

FIG. 1 is a sectional view for illustrating a configuration of an image forming apparatus, to which an electronic appliance according to a first embodiment of the present invention can be applied.

FIG. 2 is a block diagram for illustrating a configuration of a controller used for the electronic appliance according to the first embodiment.

FIG. 3 is a diagram for illustrating structure of data serially communicated between a main SoC and a sub SoC.

FIG. 4 is a timing chart for illustrating transition of signals during power-on in the first embodiment.

FIG. 5A and FIG. 5B are flowcharts for illustrating operation during the power-on in the first embodiment.

FIG. 6 is a flowchart for illustrating operation upon reception of a packet in a UART-I/F.

FIG. 7 is a timing chart for illustrating transition of signals in the first embodiment.

FIG. 8A and FIG. 8B are flowcharts for illustrating operation in the first embodiment.

FIG. 9 is a timing chart in the case of disconnection of serial communication signals in the first embodiment.

FIG. 10 is a timing chart when the sub-CPU is in an abnormal condition in the first embodiment.

FIG. 11 is a block diagram for illustrating a configuration of a controller used for an electronic appliance according to a second embodiment of the present invention.

FIG. 12 is a timing chart for illustrating transition of signals in the second embodiment.

FIG. 13A and FIG. 13B are flowcharts for illustrating operation in the second embodiment.

FIG. 14 is a block diagram for illustrating a configuration of a controller used for a related-art electronic appliance.

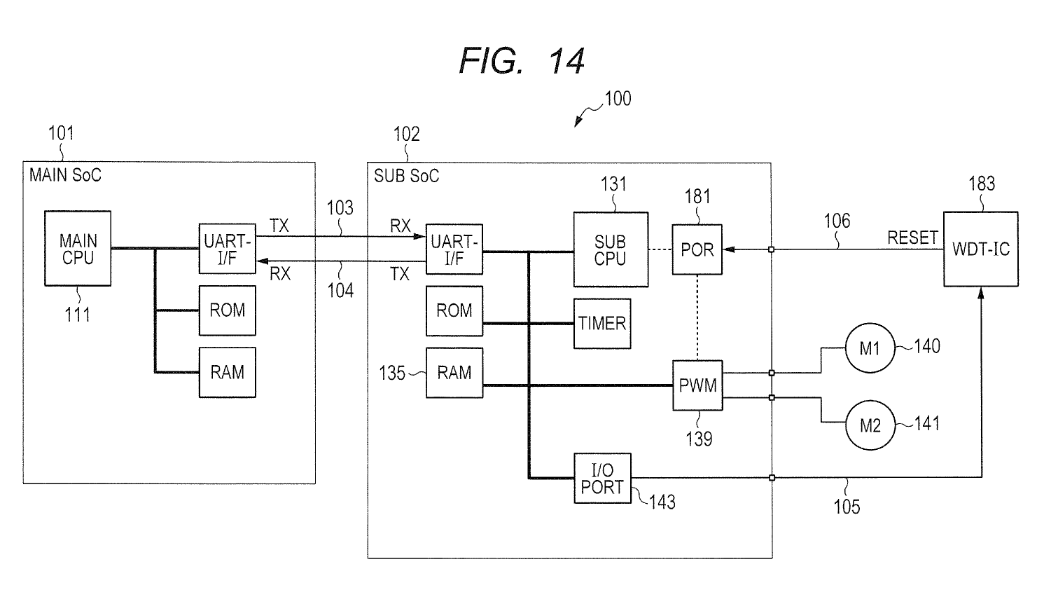

### DESCRIPTION OF THE EMBODIMENTS

Preferred embodiments of the present invention will now be described in detail in accordance with the accompanying drawings.

Embodiments for carrying out the present invention will be described below.

### First Embodiment

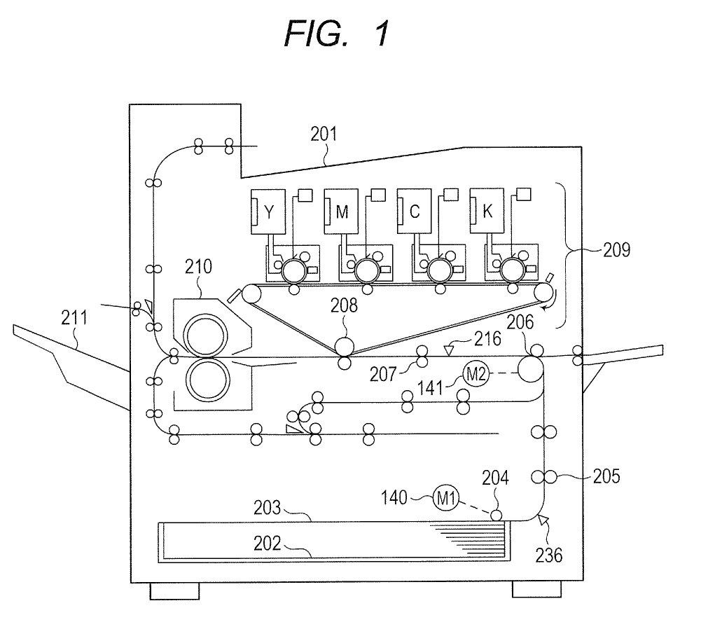

FIG. 1 is a sectional view for illustrating a configuration of an image forming apparatus, to which an electronic appliance according to a first embodiment of the present invention can be applied. A printer device 201 is used as an example of the image forming apparatus.

The printer device 201 is an apparatus configured to form an image on paper 203 stored in a paper cassette 202. The paper 203 is pulled out of the paper cassette 202 by a feeding roller 204. When the paper 203 fed from the paper cassette 202 reaches vertical path rollers 205, it is conveyed further upward to conveyance rollers 206 and registration rollers 207. The feeding roller 204 is driven by the feeding motor (Ml) 140, and the registration rollers 207 are driven by the registration motor (M2) 141.

An image forming unit 209 has, for example, a function of forming on a photosensitive drum an electrophotographic visible toner image formed of four colors that are yellow, magenta, cyan, and black, and transferring the formed toner image on a polyimide intermediate transfer belt for transmission to secondary transfer rollers 208.

The paper 203 conveyed to the registration rollers 207 is conveyed to the secondary transfer rollers 208 in synchronization with timing for image formation of an image forming portion 209, and the visible toner image formed by the image forming portion 209 is secondary-transferred onto the paper 203. To the paper 203 having passed through the secondary transfer rollers 208, the visible toner image is permanently fixed by thermal fixing rollers 210, and the paper 203 is then ejected to the paper ejection tray 211.

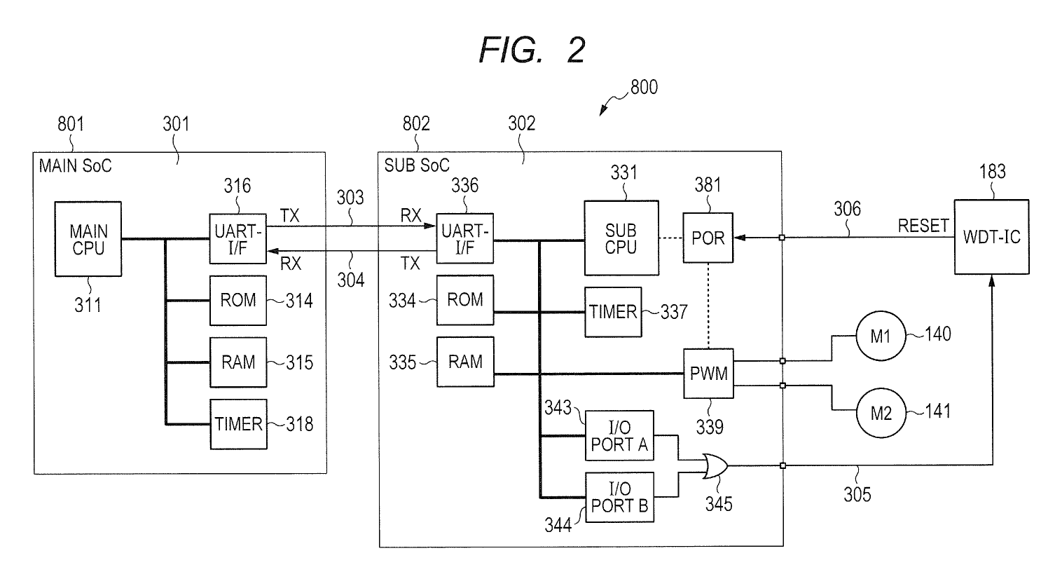

FIG. 2 is a block diagram for illustrating a configuration of a controller 800 used for the electronic appliance according to the first embodiment. A main SoC 301 is a first controller mounted on a main circuit board (first circuit board) 801. The main SoC 301 includes a main CPU (first processor) 311, a read only memory (ROM) 314, a random access memory (RAM) 315, a universal asynchronous receiver/transmitter-interface (UART-I/F) 316, and a timer 318. The main SoC 301 issues an instruction to a control circuit board in each portion of the printer device 201 to integrate entire control timing of the entire printer device 201.

The main SoC 301 and the sub SoC 302 are communicably connected by serial communication signal lines 303 and 304 as connecting lines. The serial communication signal lines 303 and 304 are formed of a serial communication transmission signal line 303 and a serial communication reception signal line 304. The transmission mentioned herein means transmission from the main SoC 301 (Tx: transmitter) to the sub SoC 302 (RX: receiver), as viewed from the main SoC 301. The reception means reception in the main SoC 301 (RX: receiver) from the sub SoC 302 (Tx: transmitter), as viewed from the main SoC 301.

The main CPU 311 reads a program stored in the ROM 314 and operates. The ROM 314 stores programs to be executed by the main CPU 311 and various pieces of data. The RAM 315 stores working data to be used when the main CPU 311 performs an operation.

The UART-I/F 316 is a two-wire serial interface in start-stop synchronous communication, and is connected to a sub circuit board (second circuit board) 802 by the serial communication transmission signal line 303 and the serial communication reception signal line 304 in bilateral directions. The UART-I/F 316 is a circuit to realize a transmission function and a reception function for serial communication signals. The transmission function is a function of transmitting transmission information, which is formed of a plurality of byte strings set from the main CPU 311, by units of eight bits, with one start bit added to the top and one stop bit added to the end, one bit at a time as a serial signal at a speed of 76,800 bps. The reception function is a function of, concerning a serial signal transmitted from a connected point, detecting a start bit, receiving one bit at a time, putting together pieces of data up to a stop bit as one-byte data each for storage into a buffer, and providing the received byte string to the main CPU 311. By repeating the above, the UART-I/F 316 can transmit and receive a byte string of a plurality of bytes.

The timer 318 has a function of outputting an interrupt signal to the main CPU 311 when counting a clock number set by the main CPU 311 in advance. The main CPU 311 is configured to be able to start desired processing by using the timer 318 at timing after predetermined time.

The sub SoC 302 is a second controller mounted on the sub circuit board (second circuit board) 802 physically separated from the main circuit board 801. The sub SoC 302 includes a sub CPU (second processor) 331, a ROM 334, a RAM 335, a UART-I/F (receiving portion) 336, a timer 337, a PWM circuit 339, a first input/output port (hereinafter referred to as “first I/O port”) 343, a second input/output port (hereinafter referred to as “second I/O port”) 344, a watchdog pulse output logic (logical operation circuit) 345, and a POR circuit 381.

The sub circuit board 802 having the sub SoC 302 mounted thereon is installed in a place away from the main circuit board 801 having the main SoC 301 mounted thereon. The main circuit board 801 and the sub circuit board 802 are connected by the communication signal lines 303 and 304. The serial communication signal lines 303 and 304 include a serial communication transmission signal line 303 and a serial communication reception signal line 304. The sub SoC 302 is operable in accordance with a request from the main SoC 301 via the serial communication line.

The sub CPU 331 reads the program stored in the ROM 334 and controls operation of the circuits on the sub circuit board 802 in accordance with the program. The ROM 334 stores programs to be executed by the sub CPU 331 and various pieces of data. The RAM 335 stores working data to be used when the sub CPU 331 performs an operation.

The UART-I/F 336 is a two-wire serial interface in start-stop synchronous communication, and is connected to the main SoC 301 by the serial communication transmission signal line 303 and the serial communication reception signal line 304 in bilateral directions. The UART-I/F 336 is a circuit to realize a reception function and a transmission function for serial communication signals (and may be a programmable logic device or the like). The reception function is a function of storing a bit string, which is transmitted to the sub SoC 302 by the serial communication transmission signal line 303, into the buffer by units of the byte string with the start bit and the stop bit removed therefrom, and outputting an interrupt signal to the sub CPU 331 when data corresponding to a predetermined byte number is stored. The reception function includes a function of performing output logic operation on the I/O port when the data in the byte string described later is a predetermined value. The transmission function is a function of transmitting a serial communication signal to the main SoC 301 by the serial communication reception signal line 304 by operation from the sub CPU 331.

The timer 337 has a function of outputting an interrupt signal to the sub CPU 331 when counting the clock number set by the sub CPU 331 in advance, similarly to the timer 318. The sub CPU 331 is configured to be able to start desired processing by using the timer 337 at timing after predetermined time.

The PWM circuit 339 includes two-system independent PWM (Pulse Width Modulation) outputs, and outputs motor clock pulse signals for driving the drive portions, such as the feeding motor 140 and the registration motor 141, at desired frequencies and ON-OFF timing.

The first I/O port (IO Port A) 343 outputs a binary signal (first signal) that is controlled by the sub CPU 331. The second I/O port (IO Port B) 344 outputs a signal (second signal) in accordance with a detection result of the serial communication packet (predetermined signal) received by the UART-I/F 336.

The watchdog pulse output logic (third output port) 345 is an OR gate, and outputs a logic L when receiving inputs of L levels from both the first I/O port (second output port) 343 and the second I/O port (first output port) 344, and outputs a logic H when receiving an input of an H level from one of the ports. The watchdog pulse (watchdog signal) 305 output from the watchdog pulse output logic 345 is input into the watchdog timer reset IC (WDT-IC) 183.

The watchdog timer reset IC 183 serving as a reset device is a negative logic and clears the count of the watchdog timer by use of a falling edge signal that switches from the H level to the L level. A constant of the watchdog timer is 500 milliseconds (msec), for example. When the falling edge signal is not input within 500 msec, the watchdog timer reset IC 183 outputs a reset signal (RESET) 306 at the L level to the sub SoC 302 for 10 msec. That is, the watchdog timer reset IC 183 resets the sub SoC 302 when the falling edge signal to switch from the H level to the L level of the watchdog pulse 305 is not input for a fixed period (500 msec in the above-mentioned example).

The power-on reset circuit (POR) 381 is a circuit to cancel a reset state of the sub CPU 331 under an AND condition where a voltage supplied to a power supply circuit (not shown) exceeds 2.9 V and the input reset signal 306 is at the H level. The power-on reset circuit 381 serves to prevent unstable operation from being performed with a voltage not in a stable state during power-on.

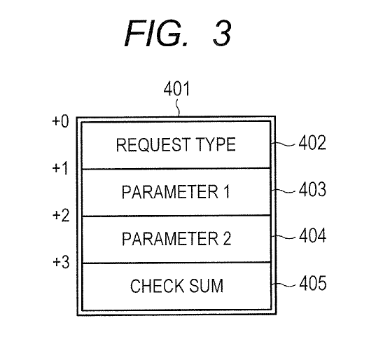

FIG. 3 is a diagram for illustrating structure of data serially communicated between the main SoC 301 and the sub SoC 302. A communication packet 401 is an illustration of a serial communication packet transmitted from the UART-I/F 316 in the main SoC 301, and is a communication packet formed of four bytes in start-stop synchronous communication. The communication packet 401 includes a request type field 402 for a counter station, parameter designation fields 403, 404, and a checksum field 405 for checking.

When a value of the request type field 402 is “0xF0”, the main SoC 301 requests the sub SoC 302 to synchronize the timing for outputting a watchdog pulse. Similarly, when the value of the request type field 402 is “0xF1”, the main SoC 301 requests the sub SoC 302 to switch the logic of the second I/O port 344 to the L level (first level) so as to output the watchdog pulse 305. When the value of the request type field 402 is “0xF2”, the main SoC 301 requests the sub SoC 302 to return the logic of the second I/O port 344 to the H level (second level) so as to stop the output of the watchdog pulse 305. The value of the request type field 402 being “0xFF” means a reply indicating successful reception of the serial communication packet transmitted immediately before. The value of the request type field 402 being another value means requesting for starting or stopping the drive of the motor, and rotational speeds and driving time in that case are stored into the parameter designation fields 403 and 404.

The checksum field 405 indicates an addition value of the values from the request type field 402 to the parameter designation fields 403 and 404, and the main CPU 311 stores the addition value at the time of its transmission. The sub CPU 331 can detect a serial communication error by checking the addition value of the values from the request type field 402 to the parameter designation fields 403 and 404 in the received serial communication packet with the value of the checksum field 405.

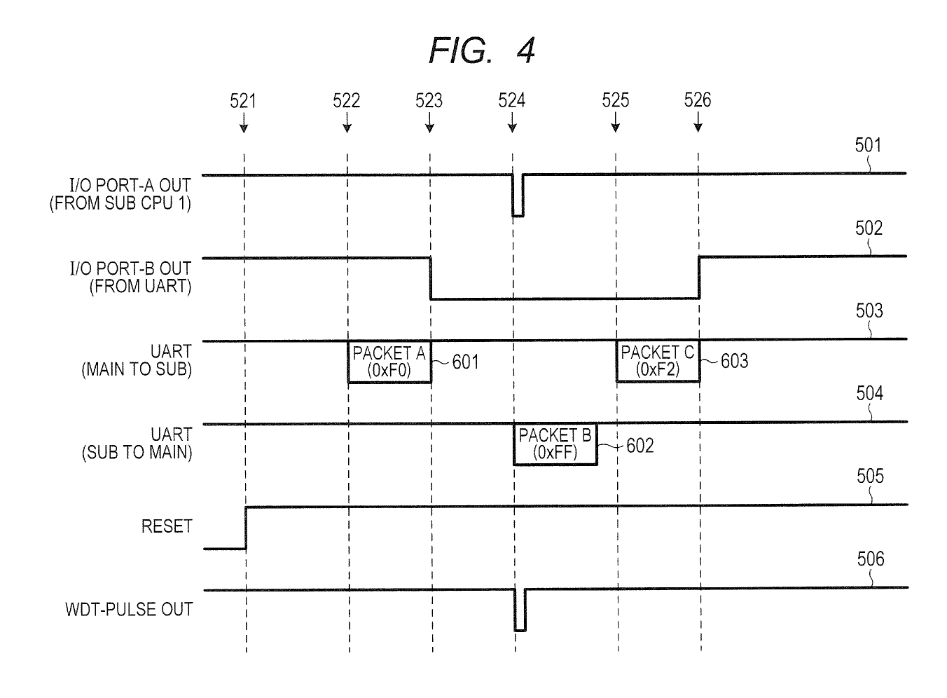

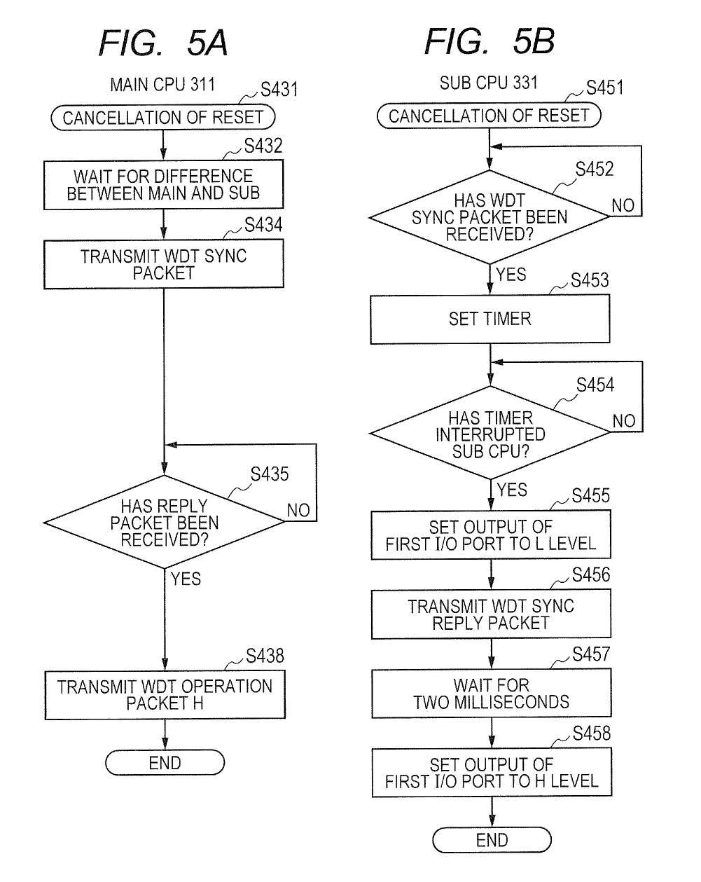

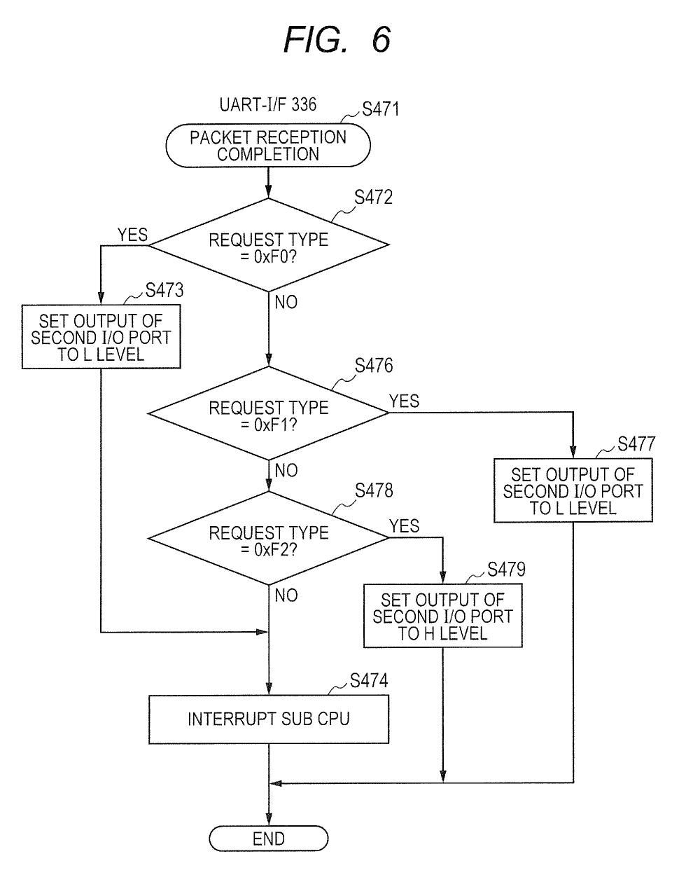

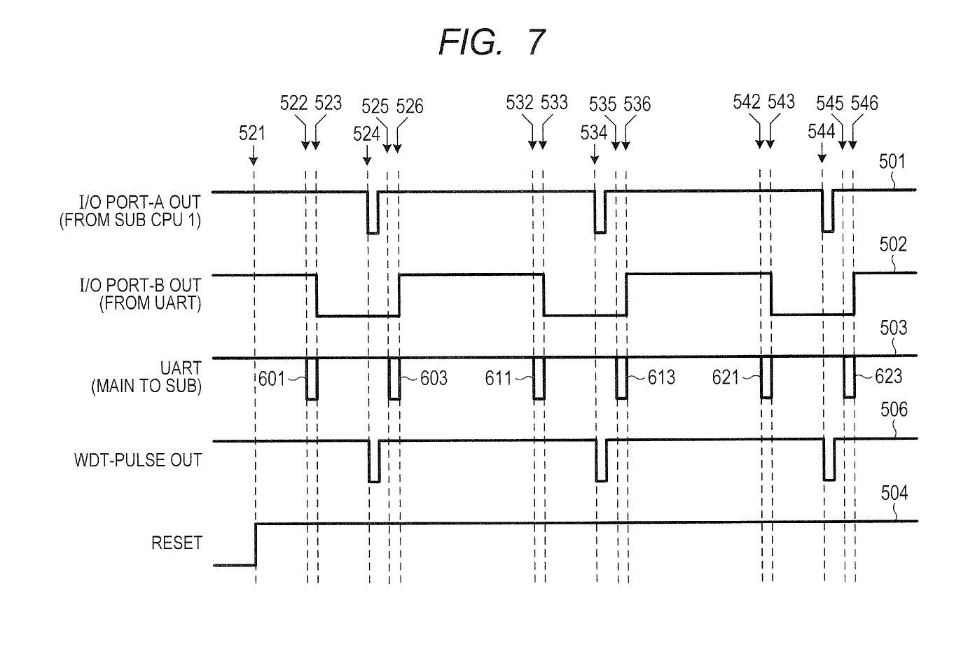

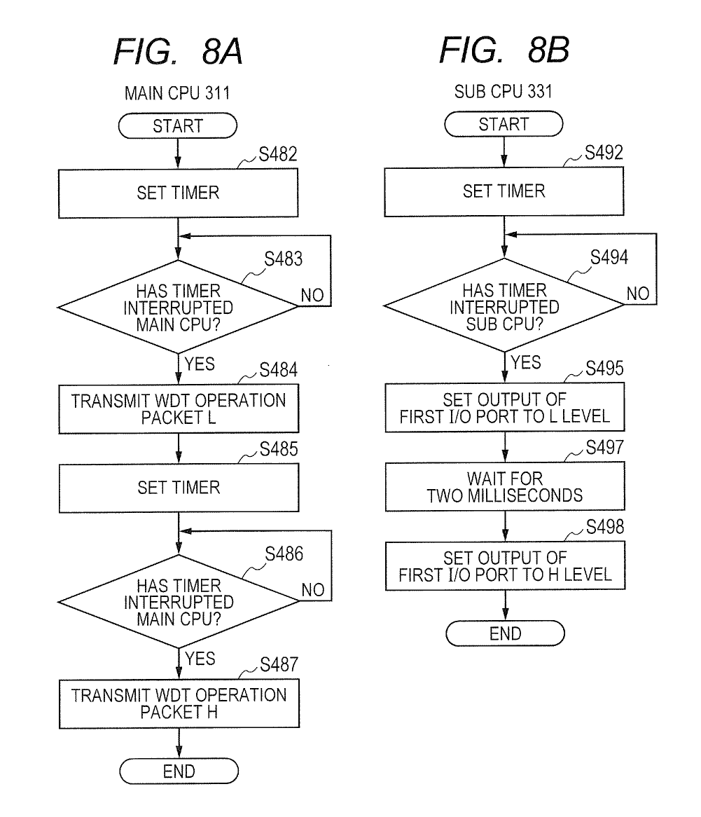

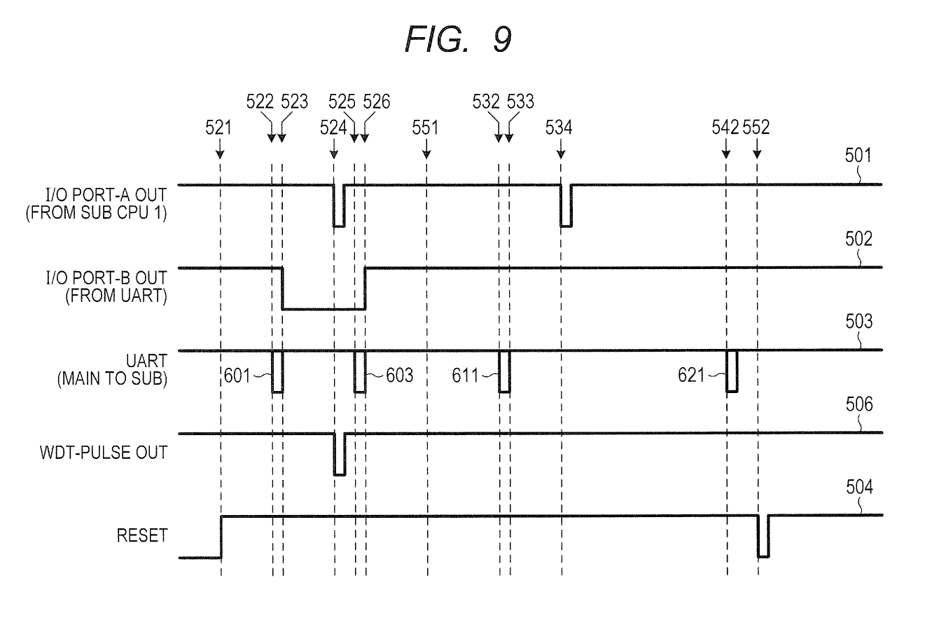

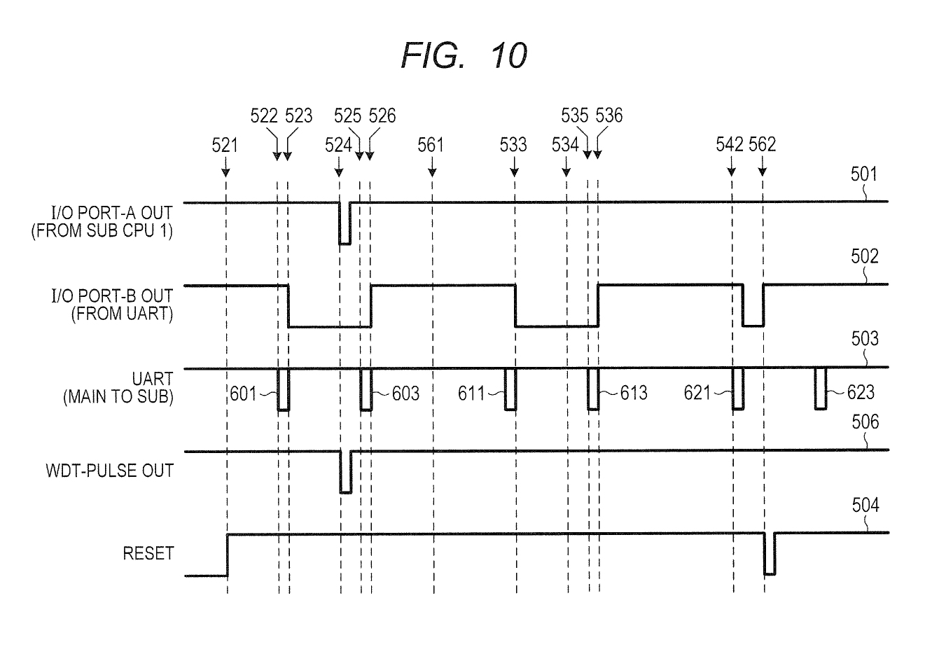

The operation of each of the main SoC 301 and the sub SoC 302 will be described below. First, operation of timing synchronization between the main SoC 301 and the sub SoC 302, which is performed during the power-on, will be described with reference to FIG. 4, FIG. 5A, FIG. 5B, and FIG. 6. Subsequently, operation in a normal condition will be described with reference to FIG. 7, FIG. 8A, and FIG.8B. Finally, operation in an abnormal condition will be described with reference to FIG. 9 and FIG. 10.

[Timing Synchronizing Operation]

FIG. 4 is a timing chart for signals on the peripheries of the main SoC 301 and the sub SoC 302 during the power-on. FIG. 5A and FIG. 5B are flowcharts for illustrating the operation of the main CPU 311 and the sub CPU 331, where FIG. 5A corresponds to the operation of the main CPU 311, and FIG. 5B corresponds to the operation of the sub CPU 331. That is, the processing of FIG. 5A is realized by the main CPU 311 executing the program recorded in the ROM 314. The processing of FIG. 5B is realized by the sub CPU 331 executing the program recorded in the ROM 334. FIG. 6 is a flowchart for illustrating determination operation upon reception of the serial communication packet in the UART-I/F 336. That is, the processing of FIG. 6 is realized by the circuit forming the UART-I/F 336. The UART-I/F 336 includes a circuit for receiving a signal and a circuit for controlling communication. The processing of FIG. 6 is executed by the circuit for controlling communication. The circuit for controlling communication (e.g., bus master) may be provided outside the I/F.

In FIG. 4, a signal 501 is a waveform of the sub CPU 331 operating the first I/O port 343. A signal 502 is a waveform of the UART-I/F 336 operating the second I/O port 344.

A signal 503 is a waveform indicating a serial communication signal transmitted from the main SoC 301 to the sub SoC 302. A signal 504 is a waveform indicating a serial communication signal transmitted from the sub SoC 302 to the main SoC 301, contrary to the signal 503.

A signal 505 is a waveform indicating shifts of the reset signal 306 that is input into the power-on reset circuit 381. A signal 506 is a waveform indicating the watchdog pulse 305 that is output by the watchdog pulse output logic 345.

When the reset state of the signal 505 is canceled by turning on the power at a time 521, the main CPU 311 and the sub CPU 331 start operation (Step S431 of FIG. 5A and Step S451 of FIG. 5B). The main CPU 311 waits for the time corresponding to a difference in initial setting time between the main SoC 301 and the sub SoC 302 (Step S432 of FIG. 5A). The sub CPU 331 initializes the UART-I/F 336 to get prepared so as to receive a serial communication signal from the main SoC 301. Further, the sub CPU 331 waits to receive a WDT sync packet (synchronization processing request) from the main CPU 311 in the main SoC 301 via the UART-I/F 336 (Step S452 of FIG. 5B).

At a time 522 when the main CPU 311 has waited for the difference in initial setting time, the main CPU 311 transmits to the sub SoC 302 a serial communication packet 601 with the value of the above-mentioned request type field 402 being “0xF0” (Step S434 of FIG. 5A). Further, the main CPU 311 waits for a reply of a reply packet from the sub SoC 302 (Step S435). Meanwhile, the UART-I/F 336 in the sub SoC 302 starts receiving the serial communication packet 601 transmitted from the above-mentioned main SoC 301.

When completing the reception of the serial communication packet 601 at a time 523 (Step S471 of FIG. 6), the UART-I/F 336 makes a content determination on the serial communication packet 601 (Steps S472, S476, and S478 of FIG. 6). When determining that the value of the request type field 402 matches “0xF0” (Yes in Step S472 of FIG. 6), the UART-I/F 336 operates the second I/O port 344 to switch the output to the L level (Step S473 of FIG. 6) and generates a reception interrupt in the sub CPU 331 (Step S474 of FIG. 6).

By the above-mentioned interrupt, the sub CPU 331 determines to have received the WDT sync packet from the main SoC 301 (Yes in Step S452 of FIG. 5B), sets the timer 337 at 4 msec from the time 523 (Step S453 of FIG. 5B), and waits for an interrupt by the timer 337 (Step S454 of FIG. 5B).

When interrupted by the timer 337 after the lapse of 4 msec, which is a time 524 (Yes in S454 of FIG. 5B), the sub CPU 331 operates the first I/O port 343 to switch the output to the L level (Step S455). The output of the first I/O port 343 shifts to the L level and the output of the second I/O port 344 shifts to the L level (i.e., the outputs of both I/O ports shift to the L level), and thus the watchdog pulse output logic 345 shifts the signal 506 from the H level to the L level. As a result, the falling edge from the H level to the L level is input into the watchdog timer reset IC 183 to clear the watchdog timer counter.

The sub CPU 331 operates the first I/O port 343 to switch the output to the L level, and at the same time replies a serial communication packet 602 to the main SoC 301 (Step S456 of FIG. 5B). The value of the request type field 402 in the replied serial communication packet 602 is “0xFF”, meaning that the sub CPU 331 has notified the main SoC 301 of successful reception of the serial communication packet 601. After the lapse of 2 msec (Step S457), the sub CPU 331 returns the output of the first I/O port 343 to the H level (Step S458).

When determining that the serial communication packet 602 replied from the sub SoC 302 has returned to the main SoC 301 (when Yes in Step S435), the main CPU 311 transmits a serial communication packet 603 with the value of the request type field 402 being “0xF2” to the sub SoC 302 at a time 525 (Step S438). Meanwhile, the UART-I/F 336 in the sub SoC 302 starts receiving the serial communication packet 603 transmitted from the above-mentioned main SoC 301.

When completing the reception of the serial communication packet 603 at a time 526 (Step S471 of FIG. 6), the UART-I/F 336 makes a content determination on the serial communication packet 601 (Steps S472, S476, and S478 of FIG. 6). When determining that the value of the request type field 402 matches “0xF2” (Yes in Step S478 of FIG. 6), the UART-I/F 336 operates the second I/O port 344 to switch the output to the H level (Step S479 of FIG. 6).

By the above-mentioned procedure, the main CPU 311 and the sub CPU 331 recognize the timing of the outputs of the watchdog pulse into the watchdog timer reset IC 183 after the power-on.

[Operation in Normal Condition]

Subsequently, procedures for the main CPU 311 and the sub CPU 331 to instruct the output of the watchdog pulse (operation in the normal condition) will be described with reference to FIG. 7, FIG. 8A, FIG. 8B, and FIG. 6.

FIG. 7 is a timing chart for illustrating temporal shifts of signals on the peripheries of the main SoC 301 and the sub SoC 302 after FIG. 4. FIG. 8A and FIG. 8B are flowcharts for illustrating the operation of the main CPU 311 and the sub CPU 331. FIG. 8A corresponds to the operation of the main CPU 311, and FIG. 8B corresponds to the operation of the sub CPU 331. That is, the processing of FIG. 8A is realized by the main CPU 311 executing the program recorded in the ROM 314. The processing of FIG. 8B is realized by the sub CPU 331 executing the program recorded in the ROM 334.

In FIG. 7, the times 521 to 526 are portions corresponding to the times 521 to 526 in FIG. 4, and thus the description thereof is omitted. The main CPU 311 sets a communication time (e.g., 200 msec after the last transmission of the serial communication packet with the value of the request type field 402 being “0xF0” or “0xF1”) in the timer 318 in advance (Step S482 of FIG. 8A) and waits for an interrupt by the timer (Step S483 of FIG. 8A). When interrupted by the timer at a time 532 (Yes in Step S483 of FIG. 8A), the main CPU 311 transmits a serial communication packet 611 with the value of the request type field 402 being “0xF1” to the sub SoC 302 via the UART-I/F 316 (Step S484 of FIG. 8A). Meanwhile, the UART-I/F 336 in the sub SoC 302 starts receiving the serial communication packet 611 transmitted from the main SoC 301.

When completing the reception of the serial communication packet 611 at a time 533 (Step S471 of FIG. 6), the UART-I/F 336 makes a content determination on the serial communication packet 611 (Steps S472, s476, and S478 of FIG. 6). When determining that the value of the request type field 402 matches “0xF1” (Yes in Step S476 of FIG. 6), the UART-I/F 336 operates the second I/O port 344 to switch the output to the L level (Step S477 of FIG. 6).

After Step S458 of FIG. 5B, the sub CPU 331 sets a watchdog pulse output time (e.g., 200 msec after the first I/O port 343 is operated to switch the output to the L level the last time) in the timer 337 in advance (Step S492 of FIG. 8B) and waits for an interrupt by the timer 337 (Step S494 of FIG. 8B). When interrupted by the timer 337 at a time 534 (Yes in S494 of FIG. 8B), the sub CPU 331 operates the first I/O port 343 to switch the output to the L level (Step S495 of FIG. 8B).

The output of the first I/O port 343 shifts to the L level and the output of the second I/O port 344 shifts to the L level (i.e., both outputs shift to the L level), and thus the watchdog pulse output logic 345 shifts the signal 506 from the H level to the L level. As a result, the falling edge from the H level to the L level is input into the watchdog timer reset IC 183 to clear the watchdog timer counter.

Immediately after Step S495, the sub CPU 331 waits for the lapse of 2 msec (Step S497) and returns the output of the first I/O port 343 to the H level (Step S498), to complete the processing illustrated in the flowchart of FIG. 8B.

After transmitting the serial communication packet 611 in Step S484, the main CPU 311 sets the timer 318 again (Step S485 of FIG. 8A) and waits for an interrupt by the timer 318 (Step S486 of FIG. 8A). When interrupted by the timer 318 at a time 535 (Yes in Step S486 of FIG. 8A), the main CPU 311 transmits a serial communication packet 613 with the value of the request type field 402 being “0xF2” to the sub SoC 302 via the UART-I/F 316 (Step S487), to complete the processing illustrated in the flowchart of FIG. 8A. Meanwhile, the UART-I/F 336 in the sub SoC 302 starts receiving the serial communication packet 613 transmitted from the above-mentioned main SoC 301.

When completing the reception of the serial communication packet 613 at a time 536 (Step S471 of FIG. 6), the UART-I/F 336 makes a content determination on the serial communication packet 611 (Steps S472, S476, and S478 of FIG. 6). When determining that the value of the request type field 402 matches “0xF2” (Yes in Step S478 of FIG. 6), the UART-I/F 336 operates the second I/O port 344 to return the output to the H level (Step S479 of FIG. 6).

The period in which the main SoC 301 sets the second I/O port 344 at the L level for fixed time by use of the serial communication packet 611 and the serial communication packet 613 (the timer setting time in Step S485 of FIG. 8A) is set longer than the period in which the sub CPU 331 sets the first I/O port 343 at the L level (2 msec in Step S497 of FIG. 8B) in consideration of operation by the serial communication.

The main CPU 311 and the sub CPU 331 repeatedly execute the processing illustrated in FIG. 8A and the processing illustrated in FIG. 8B, respectively. Events at times 542 to 546 in FIG. 7 occur 200 msec after the time 532, and similarly, by serial communication packets 621 and 623 transmitted from the main SoC 301 to the sub SoC 302 and a timer interrupt generated in the sub CPU 331 at the time 544, the watchdog pulse output logic 345 outputs a falling edge from the H level to the L level, with the result that the watchdog pulse 305 is output and the watchdog timer is cleared.

In this manner, when both the condition for outputting the watchdog pulse 305 from the main SoC 301 by use of the serial communication packet and the condition for outputting the watchdog pulse 305 from the CPU 331 built in the sub SoC are satisfied, the falling edge is output to the watchdog timer reset IC 183, thereby enabling operation of the load drive source in such a form as to ensure that both CPUs are in normal operation.

[First Example of Operation in Abnormal Condition]

Next, with reference to FIG. 9, processing will be described in the case of occurrence of a state where the serial communication packet does not reach the sub SoC 302 from the main SoC 301, such as the case of disconnection of the serial communication signal line or the case of the serial communication reception module coming into the state of being unable to continue normal operation.

FIG. 9 is a timing chart for illustrating temporal shifts of signals on the peripheries of the main SoC 301 and the sub SoC 302 in the case of disconnection of the serial communication signal. In FIG. 9, the times 521 to 526 are portions corresponding to the times 521 to 526 in FIG. 4, and thus the description thereof is omitted.

As illustrated in FIG. 9, when the serial communication transmission signal line 303 from the main SoC 301 to the sub SoC 302 is disconnected at a time 551 between the time 526 and the time 533, the serial communication packet 611 transmitted at the time 532 does not reach the sub SoC 302. Consequently, the UART-I/F 336 does not operate the second I/O port 344, and the signal 502 thus remains at the H level.

Meanwhile, the sub CPU 331 continues the operation of the first I/O port 343 when the sub CPU 331 is at least in the state of being able to receive a timer interrupt from the timer 337. Thus, at the time 534, the sub CPU 331 operates the first I/O port 343 to switch the output to the L level, and returns the output to the H level after 10 msec.

However, the signals to be input into the watchdog pulse output logic 345 are not both aligned at the L level, and thus the signal 506 remains at the H level. Consequently, the watchdog timer reset IC 183 generates a reset at a time 552, which is 500 msec after the time 524 when the watchdog pulse 305 was output the last time.

As described above, even in the case of disconnection of the serial communication transmission signal line 303 from the main SoC 301 to the sub SoC 302, it is possible to reset the sub SoC 302 and bring the device into the safe state according to the first embodiment.

[Second Example of Operation in Abnormal Condition]

Next, with reference to FIG. 10, processing will be described in a case where the serial communication packet has reached the sub SoC 302 from the main SoC 301, but the sub CPU 331 or the timer 337 is not in normal operation.

FIG. 10 is a timing chart for illustrating temporal shifts of signals on the peripheries of the main SoC 301 and the sub SoC 302 when the CPU built in the sub SoC is in an abnormal condition. In FIG. 10, the times 521 to 526 are portions corresponding to the times 521 to 526 in FIG. 4, and thus the description thereof is omitted.

As illustrated in FIG. 10, at a time 561 between the time 526 and the time 533, an abnormality occurred in part of the work RAM 335 or the timer 337 used by the program of the sub CPU 331 in the sub SoC 302. After that, at the time 533, the UART-I/F 336 operates the second I/O port 344 upon reception of the packet from the main SoC to shift the signal 502 to the L level. However, the sub CPU 331 cannot operate the first I/O port 343 at a time 534 due to the abnormality described above, and thus the logic of the signal 501 remains at H. This keeps the signals to be input into the watchdog pulse output logic 345 from being both aligned at the L level, and thus the signal 506 remains at the H level. Consequently, the watchdog timer reset IC 183 generates a reset at a time 562, which is 500 msec after the time 524 when the watchdog pulse was output the last time.

As described above, in the configuration where the SoC is distributed to a plurality of circuit boards formed of the main circuit board and the sub circuit board, when the watchdog IC is installed on each circuit board, the watchdog pulse 305 is output under a condition where both the instruction to output the watchdog pulse instructed by communication from the main circuit board 801 to the sub circuit board 802 and the instruction to output the watchdog pulse internally generated by the CPU built in the sub SoC 302 (sub CPU 331) are met. With such a configuration, even when an abnormality occurs in part of the work RAM 335 or the timer 337 used by the program of the sub CPU 331 and the sub CPU 331 cannot detect the abnormality, it is possible to bring the device into the safe state by resetting the sub SoC 302 according to the first embodiment.

According to the first embodiment, it is possible to appropriately deal with an unexpected abnormality in the printer device 201 including the controller 800 configured by being divided into the plurality of circuit boards 801 and 802.

### Second Embodiment

The configuration of the protection circuit using the watchdog timer reset IC 183 has been described in the first embodiment, but the present invention is not limited thereto. An output of the I/O port in the circuit to receive communication from the main SoC 301 and a logical operation result of outputs of the I/O ports 343 and 344 controlled by the sub CPU 331 in a sub SoC 307 may be input into an enable terminal of a three-state buffer 383 for outputting an actuator drive signal, or input into an on-signal of a power supply logic of a motor driver.

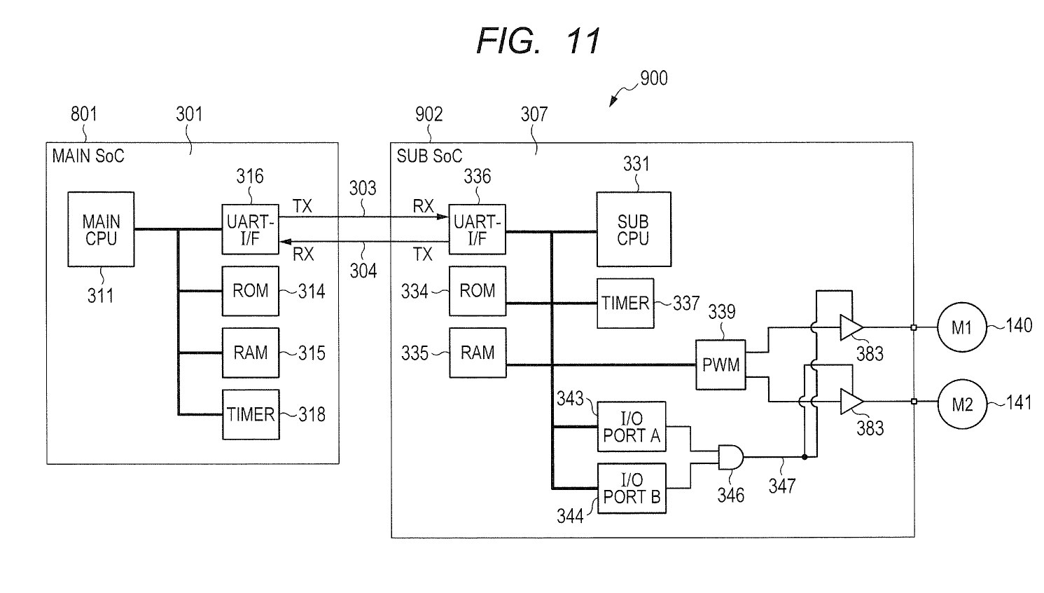

The example of connecting the motor driver to the output of the actuator drive signal via the three-state buffer 383 will be described as an example with reference to FIG. 11. FIG. 11 is a block diagram for illustrating a configuration of a controller 900 used for an electronic appliance of a second embodiment of the present invention. The main SoC 301 of the first embodiment illustrated in FIG. 2 and the sub SoC 307 similar to the sub SoC 302 may be connected by serial communication signal lines (the serial communication transmission signal line 303 and the serial communication reception signal line 304). The same numeral is added to the same structure as that in FIG. 2.

A main SoC 301 is a first controller mounted on a main circuit board (first circuit board) 801. The sub SoC 307 is a second controller mounted on a sub circuit board (second circuit board) 902 physically separated from the main circuit board 801. The sub SoC 307 includes the sub CPU 331, the ROM 334, the RAM 335, the UART-I/F 336, the timer 337, the PWM circuit 339, the first I/O port 343, the second I/O port 344, a motor output enable control logic 346, and the three-state buffer 383. In FIG. 11, outputs of the first I/O port 343 and the second I/O port 344 are connected to the motor output enable control logic 346. The motor output enable control logic 346 is an AND gate, and outputs the logic H when receiving inputs of the H level from both the first I/O port 343 and the second I/O port 344, and outputs the logic L when receiving an input of the L level from one of the ports. A motor output enable signal 347 being an output of the motor output enable control logic 346 is connected to the three-state buffer 383.

The three-state buffers 383 are buffer circuits installed between an output of the PWM circuit 339 and the feeding motor (M1) 140, and between an output of the PWM circuit 339 and the registration motor (M2) 141, respectively. The three-state buffer 383 is a circuit that outputs an input from the PWM circuit 339 as it is when the motor output enable signal 347 is at the H level, whereas bringing the outputs to the feeding motor 140 and the registration motor 141 into an Hi-Z state when the motor output enable signal 347 is at the L level. That is, the three-state buffer 383 functions so as to allow the drive of the feeding motor 140 and the registration motor 141 when the motor output enable signal 347 is at the H level, whereas not allowing the drive of the feeding motor 140 and the registration motor 141 when the motor output enable signal 347 is at the L level.

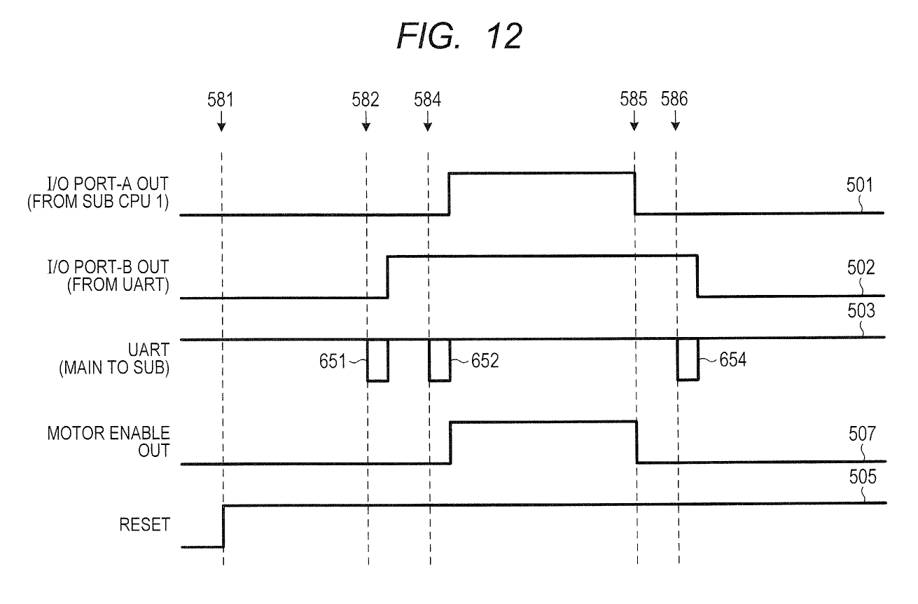

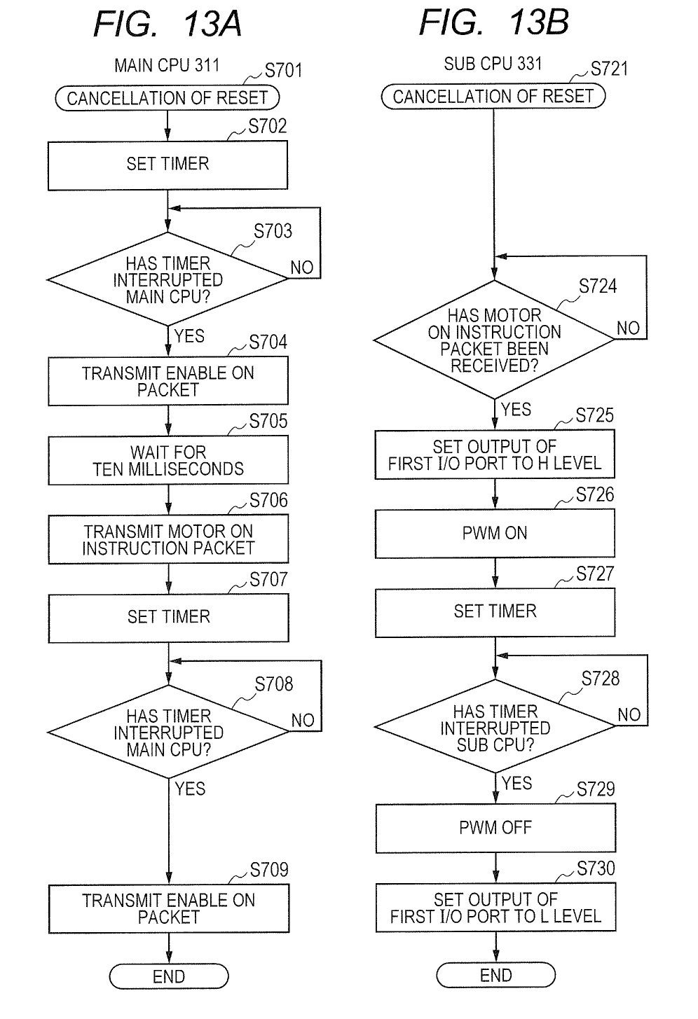

A protection mechanism of the actuator operation in the above-mentioned configuration will be described with reference to FIG. 12, FIG. 13A, and FIG. 13B. FIG. 12 is a timing chart for illustrating temporal shifts of signals on the peripheries of the main SoC 301 and the sub SoC 307 in the second embodiment. FIG. 13A and FIG. 13B are flowcharts for illustrating the operation of the main CPU 311 and the sub CPU 331 in the second embodiment. FIG. 13A corresponds to the operation of the main CPU 311, and FIG. 13B corresponds to the operation of the sub CPU 331. That is, the processing of FIG. 13A is realized by the main CPU 311 executing the program recorded in the ROM 314. The processing of FIG. 13B is realized by the sub CPU 331 executing the program recorded in the ROM 334. Determination made upon reception of the serial communication packet in the UART-I/F 336 is similar to that in FIG. 6, and thus the description thereof is omitted.

In FIG. 12, a signal 507 is a waveform indicating a logic state of the motor output enable signal 347. At a time 581, the power is turned on and the reset states of the main CPU 311 and the sub CPU 331 are cancelled (Step S701 of FIG. 13A and Step S721 of FIG. 13B). An initial value of each of the first I/O port 343 and the second I/O port 344 at that point in time is a logic L (502 and 503).

When the reset state is cancelled (Step S701 of FIG. 13A), the main CPU 311 sets a timer for use until a time 582 to the timer 318 (Step S702 of FIG. 13A) and waits for an interrupt by the timer 318 (Step S703 of FIG. 13A). The sub CPU 331 initializes the UART-I/F 336 to get prepared so as to receive a serial communication signal from the main SoC 301. Further, the sub CPU 331 waits to receive a serial communication packet (652, described later) containing an order from the main SoC 301 to drive the motor via the UART-I/F 336 (Step S724 of FIG. 13B).

When interrupted by the timer at the time 582 (Yes in Step S703 of FIG. 13A), the main CPU 311 transmits a serial communication packet 651 toward the sub SoC 307 (Step S704 of FIG. 13A). Meanwhile, the UART-I/F 336 in the sub SoC 307 receives the serial communication packet 651 transmitted from the main SoC 301 and switches the output of the second I/O port 344 to the logic H.

The main CPU 311 waits for 10 msec from the processing in Step S704 (Step S705 of FIG. 13A), transmits, to the sub SoC 307, a serial communication packet 652 containing an order for the sub CPU 331 to drive the motor at a time 584 (Step S706), sets a timer for use until a time 586 to the timer 318 (Step S707 of FIG. 13A), and waits for an interrupt by the timer (Step S708 of FIG. 13A).

Upon reception of the serial communication packet 652 containing the order to drive the motor, which is transmitted in Step S706, the UART-I/F 336 interrupts the sub CPU 331. Upon reception of the reception interrupt, the sub CPU 331 reads a received value register of the UART-I/F 336, and when determining to have received the serial communication packet 652 containing the order to drive the motor (Yes in Step S724 of FIG. 13B), the sub CPU 331 switches the first I/O port 343 to the logic H (Step S725 of FIG. 13B) and turns on the PWM circuit 339 (Step S726 of FIG. 13B).

The inputs into the motor output enable control logic 346 are both at the H level, and thus as indicated by the signal 507, the motor output enable signal 347 from the motor output enable control logic 346 switches to the H level. As a result, the output logic of the three-state buffer 383 switches from the Hi-Z state to the state of transmitting the output of the PWM circuit 339.

After that, the sub CPU 331 sets the timer used until a time 585 instructed by the serial communication packet 652 to the timer 337 (Step S727 of FIG. 13B). When interrupted by the timer 337 at the time 585 (Step S728 of FIG. 13B), the sub CPU 331 stops the output of the PWM circuit 339 to complete the drive of the motor (Step S729 of FIG. 13B) and switches the first I/O port 343 to the logic L (Step S730 of FIG. 13B). With this, the motor output enable signal 347 from the motor output enable control logic 346 also switches to the L level as indicated by the signal 507.

Then, upon reception of the timer interrupt at the time 586 (YES in Step S708 of FIG. 13A), the main CPU 311 transmits a serial communication packet 654 to the sub SoC 307 (Step S709 of FIG. 13A). The UART-I/F 336 having received this returns the output of the second I/O port 344 to the logic L. At this time, even when the sub CPU 331 comes into the state of being unable to accept an interrupt from the timer 337 for some reason, the serial communication packet 654 from the main SoC 301 can turn off the motor output enable signal 347.

With the above-mentioned configuration, even when the sub CPU 331 turns on the PWM circuit 339 at unintentional timing due to a breakdown of the RAM 334 in an attempt to drive the feeding motor 140 and the registration motor 141, a signal to drive the motor is not output unless a communication packet for setting the input of the motor output enable control logic 346 to the logic H reaches the sub CPU 331 from the main SoC 301. Further, even when the sub CPU 331 cannot stop the PWM circuit 339 or cannot return the first I/O port 343 to the logic L due to the breakdown of the RAM 334 after turning-on of the PWM circuit 339, the signal to drive the motor can be stopped by the communication packet from the main SoC 301.

As described above, the output enable control is performed on the actuator connected to the sub SoC 307 by the operation logic of the output logic of the sub CPU 331 built in the sub SoC 307 and the output logic controlled by the serial communication packet from the main SoC 301, which can bring the device into the safe state even when the sub SoC 307 comes into an uncontrollable state.

As described above, in the apparatus including the controller 900 configured by being divided into the plurality of circuit boards 801 and 902, such as an appliance formed of the plurality of CPUs 311 and 331 and SoCs 301 and 307 connected by the serial communication, it is possible to further enhance the safety against an unexpected abnormality. That is, it is possible to appropriately deal with an unexpected abnormality in the printer device 201 including the controller 900 configured by being divided into the plurality of circuit boards 801 and 902.

The above-mentioned configuration and details of various kinds of data may be formed of various configurations and details depending on the use and purpose. Embodiments have been described above, but the present invention may be embodied as a system, apparatus, method, program, or storage medium, for example. Specifically, the present invention may be applied to a system formed of a plurality of devices, or to an apparatus formed of one device. All configurations obtained by combining the above-mentioned embodiments are encompassed by the present invention.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Moreover, the present invention may be applied to a system formed of a plurality of devices, or to an apparatus formed of one device. The present invention is not limited to the above-mentioned embodiments, and various modifications (including an organic combination of the embodiments) may be made thereto based on the spirit of the present invention without departing from the scope of the present invention. In other words, all configurations obtained by combining the above-mentioned embodiments and modification examples thereof are encompassed by the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-238158, filed Dec. 8, 2016, which is hereby incorporated by reference herein in its entirety.

What is claimed is:

1. An electronic appliance, comprising:
a first circuit board including a first processor;
a second circuit board;
a communication signal line configured to connect between the first circuit board and the second circuit board; and
a watchdog timer reset integrated circuit,
wherein the second circuit board includes:
a second processor;
a receiving portion configured to receive a signal input via the communication signal line;
a first input/output port configured to output a first signal based on an instruction from the second processor;
a second input/output port configured to output a second signal in response to the receiving portion receiving a predetermined signal from the first processor; and
a logical operation circuit configured to output a watchdog signal based on a logical operation result of the first signal and the second signal, and
wherein the watchdog timer reset integrated circuit is configured to output a reset signal for resetting the second processor based on the watchdog signal.

2. An electronic appliance according to claim 1, wherein the first processor is configured to request a synchronization processing for controlling a timing at which the second processor outputs the instruction.

3. An electronic appliance according to claim 2,
wherein the second circuit board further includes a timer,
wherein the timer is reset by the synchronization processing, and
wherein the second processor outputs the instruction in response to an interrupt from the timer.

4. An electronic appliance according to claim 1, wherein the predetermined signal contains a signal to control a level of the second signal to reach a first level and a signal to control the level of the second signal to reach a second level.

5. An electronic appliance, comprising:
a first controller provided on a first circuit board;
a second controller provided on a second circuit board physically separated from the first controller, and configured to operate in response to a request from the first controller;
a connecting line which communicably connects between the first controller and the second controller; and
a reset device configured to reset the second controller when a watchdog pulse is not input for a fixed period,
wherein the first controller requests the second controller to output the watchdog pulse via the connecting line, and
wherein the second controller includes:
a first output port configured to output a first signal in response to a request from the first controller;
a second output port configured to output a second signal when a request for outputting a watchdog pulse is made in the second controller; and
a third output port configured to output the watchdog pulse to the reset device based on the first signal and the second signal.

6. An electronic appliance according to claim 5,
wherein the third output port is configured to output the watchdog pulse when both the first signal and the second signal are output, and
wherein the third output port is configured to avoid outputting the watchdog pulse when at least any one of the first signal and the second signal is not output.

7. An electronic appliance according to claim 5, wherein the first controller and the second controller are configured to synchronize a timing at which an output of the watchdog pulse is requested from the first controller and a timing at which the second output port outputs the second signal.

8. An electronic appliance according to claim 5, wherein the second controller is configured to control operation of a drive portion in response to a request from the first controller.

9. An electronic appliance according to claim 5, wherein the electronic appliance comprises an image forming apparatus.

10. An electronic appliance, comprising:
a first controller provided on a first circuit board;
a second controller provided on a second circuit board physically separated from the first controller, and configured to operate in accordance with an instruction from the first controller; and
a connecting line which communicably connects between the first controller and the second controller,
wherein the first controller requests the second controller to allow drive of a driving portion via the connecting line, and
wherein the second controller includes:
a first output port configured to output a first signal in accordance with a request from the first controller;
a second output port configured to output a second signal when the drive of the drive portion is allowed in the second controller; and
an allowing device configured to allow the drive of the driving portion based on the first signal and the second signal.

11. An electronic appliance according to claim 10, wherein the allowing device is configured to allow the drive of the driving portion when both the first signal and the second signal are output, and the allowing device is configured to avoid allowing drive of the driving portion when at least any one of the first signal and the second signal is not output.

12. An electronic appliance according to claim 10, wherein the electronic appliance comprises an image forming apparatus.
